(19) United States
(12) Patent Application Publication
(10) Pub. No.: US 2018/0186421 A1
(43) Pub. Date: Jul. 5, 2018

(54) AUTOMATED BRAKE LIGHT INITIATING DEVICE FOR MOTORCYCLE

(71) Applicants: MARK GOODSON, CORINTH, TX (US); KEVIN DAVIS, CORINTH, TX (US)

(72) Inventors: MARK GOODSON, CORINTH, TX (US); KEVIN DAVIS, CORINTH, TX (US)

(21) Appl. No.: 15/397,183

(22) Filed: Jan. 3, 2017

(51) Int. Cl. B62J 6/04; B60Q 1/44; B62J 6/00; G01S 19/14

(52) U.S. Cl. CPC B62J 6/04; G01S 19/14; B62J 6/001; B60Q 1/44

(57) ABSTRACT

This invention derives both velocity and acceleration (deceleration) of a motor vehicle (typically a motorcycle), and turns on brake lights accordingly. In that motorcyclists balance their vehicles with both feet when stopped at a traffic light, the brake pedal will not be depressed, and thus the brake light may or may not be illuminated, depending upon hand position. This invention senses the stationary vehicle in this case and illuminates the brake light accordingly. Similarly, in that some deceleration activities by motorcyclists are executed by a hard downshift, the vehicle can drastically slow down without activation of the brake light; this sudden deceleration is also sensed by the invention and similarly results in illumination of the brake lights. Sensing of these conditions is carried out by a velocity signal (derived from the motorcycle) or by the incorporation of an internal GPS receiver.

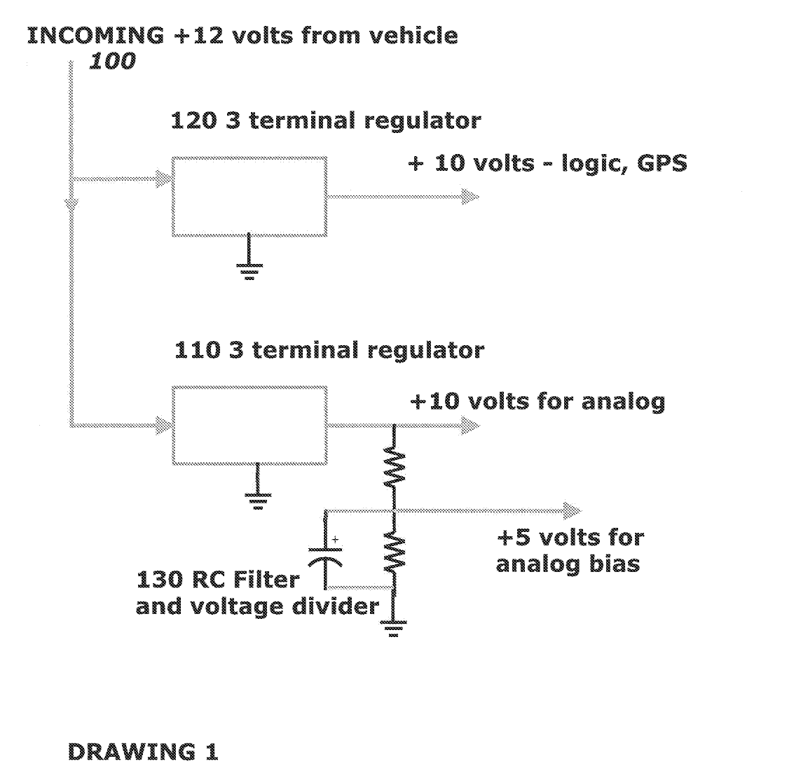

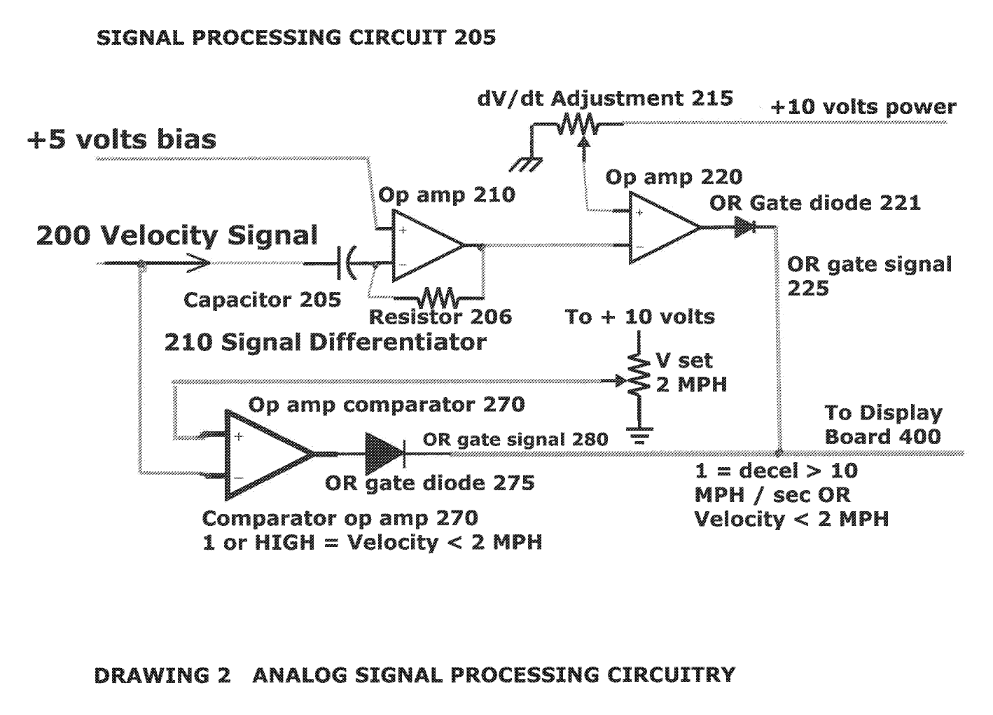

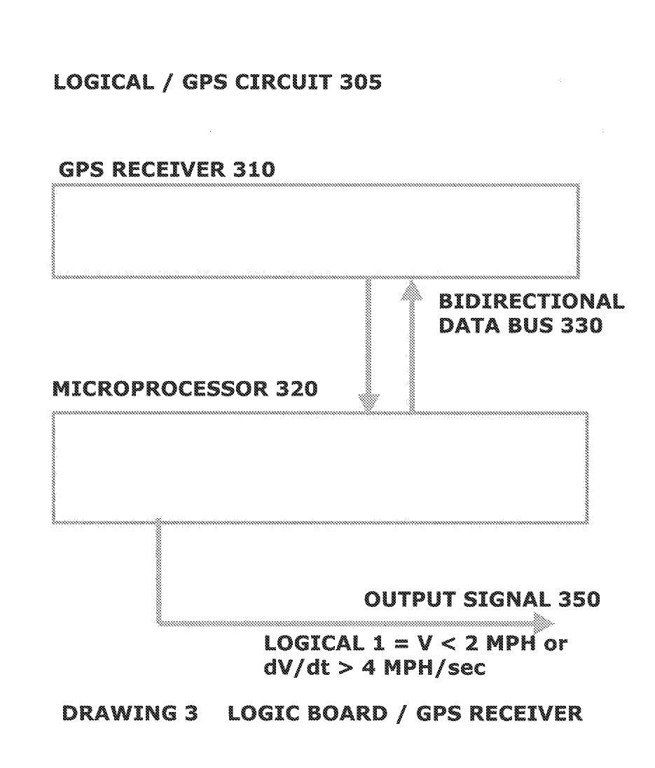

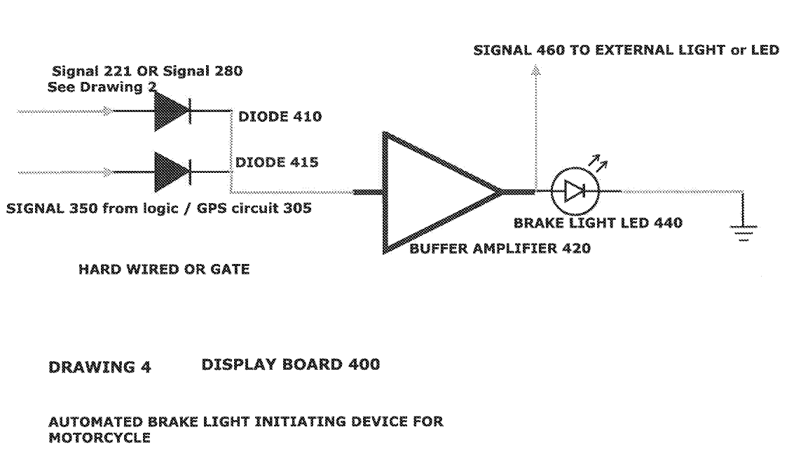

### CROSS REFERENCE TO RELATED APPLICATIONS

Not applicable.

### PARTIAL WAIVER OF COPYRIGHT

All of the material in this patent application is subject to copyright protection under the copyright laws of the United States and of other countries. As of the first effective foiling date of the present application, this material is protected as unpublished material.

However, permission to copy this material is hereby granted to the extent that the copyright owner has no objection to the facsimile reproduction by anyone of the patent documentation or patent disclosure, as it appears in the USPTO patent file or records, but otherwise reserves all copyright rights whatsoever.

### STATEMENT REGARDING FEDERALLY SPONSORED RESEARCH OR DEVELOPMENT

Not Applicable

### REFERENCE TO A MICROFICHE APPENDIX

Not Applicable

### FIELD OF THE INVENTION

The present invention generally applies to a brake light signaling system for motorcycles and other such motorized vehicles. As is well appreciated, motor vehicles in the US make use of a brake pedal switch in the braking circuit, with depression of the brake pedal actuating the switch and causing illumination of brake lights that are situated at the rear of the vehicle. While this same technology is used on motorcycles, there are problems that make this conventional circuit design ineffective in certain situations.

At stop lights, there is a tendency for operators (drivers) to balance the stationary bike (motorcycle) by placing both feet on the ground. This action means that the actuation of the brake light by means of the foot brake pedal does not alert a moving car approaching the rear of the motorcycle that the motorcycle is stopped. In addition, the small size of the motorcycle makes it difficult to visibly perceive.

A second disadvantage that the motorcycle has in terms of conspicuity of the visible brake light is that some motorcycle operators brake (decelerate) their vehicles by downshifting (changing to lower gears) and turning the internal combustion engine into a very effective braking system. This engine braking system obviously does not depress the brake light switch, illuminate the brake light, or rely on friction braking of drum or disc brakes. Nevertheless, the motorcycle still decelerates (brakes) without the brake light activating.

For the reasons explained above, it is desirable to improve upon these shortcomings by means of an invention that in realtime senses deceleration or senses a stationary condition and thus causes illumination of the brake light.

### BRIEF DESCRIPTION OF THE DRAWINGS

Drawing 1 depicts the schematic of the power distribution and power (voltage) regulation of the invention

Drawing 2 depicts the analog signal processing circuitry, whereby a voltage signal that is generated by the motorcycle is analyzed for acceleration and deceleration.

Drawing 3 depicts a logic board and GPS receiver, whereby GPS coordinates are obtained, and velocity and changes thereof are computed mathematically from the received GPS signals and the acceleration or deceleration is computed.

Drawing 4 depicts the display board, which receives signals from the analog processing circuitry (Drawing 2) and the GPS receiver and logic board (Drawing 3) and causes red LEDs to illuminate when the motorcycle is heavily decelerating or is at rest.

### THEORY OF OPERATION

The invention is designed to illuminate an internal LED brake light (facing rearward on the motorcycle) or externally power the rear brake light of a motorcycle when the motorcycle chassis has motion that mimics deceleration or stopping, or in fact has stopped. The invention does this by sensing velocity and/or deceleration (acceleration).

Referring to Drawing 1, 100 Input Power takes chassis ground and a nominal 12 volt power source from the motorcycle and makes this supply voltage available to the various electronic components within the invention. Two three-terminal regulators 110 and 120 (such as National Semiconductor 7810 and 7805) provide +10 volts (Vcc) for the signal processing circuits and +5 volts for the logic (GPS receiver) circuits respectively. A resistor capacitor network 130 is a conventional filtered voltage divider that provides Vcc/2 (5 volts nominal) for the bias voltages of the various analog integrated circuits within the invention.

Referring to Drawing 2. On some motorcycles, there is a voltage signal produced that is DC, and it is proportional to the velocity of the vehicle. As an example, some manufacturers provide a DC voltage that is scaled at a ratio of 1 volt DC for every 10 MPH of velocity. Thus, the voltage from such an output on the motorcycle would be 3.0 volts for a 30 MPH velocity. This signal is sent for processing by the invention by the signal conductor or wire velocity 200 to analog processing circuit 205. Analog processing circuit 205 computes both deceleration and senses the velocity signal, and outputs a logical 1 (HIGH) whenever any of the following two conditions are met:
Dv/dt>10 MPH/second
Velocity<2 MPH

Signal 200 is fed to a differentiating op amp, 210. The differentiating op amp 210 produces a voltage signal that is proportional to the derivative of the change in velocity, or dV/dt. Should this signal exceed a preset level, such as a negative 10 MPH change in velocity in one second or less than one second, a comparator op amp 220 processes the signal from the differentiator op amp 210 and accordingly produces an output “high” signal 225. The potentiometer DV/dt adjustment 215 provides the set or trip point for excess deceleration. The output signal from op amp 220 is fed through a OR gate diode 221, which functions as part of a hard wired diode OR gate, and is a 1 or HIGH level whenever deceleration is greater than 10 MPH.

Velocity signal 200 is also fed to an op amp 270 which compares the velocity indicated on velocity signal 200 to an approximate 0.2 volt level. The op amp 270 functions as a level comparator. If the indicated velocity of the motorcycle is 2 MPH or less, the op amp 270 generates a “high” signal level which is fed through OR gate diode 275, and this OR′d signal 280 is then fed to the to the display board 400.

In that some motorcycles do not have a voltage signal proportional to velocity, the invention also includes an internal GPS receiver. Referring to Drawing 3. A logical/GPS circuit 305 consists of a GPS receiver 310 I and microprocessor 320. This GPS receiver is programmed to acquire sets of GPS coordinates (longitude and latitude) at the rate of 5 pairs or sets per second. A microprocessor 320 receives these coordinates via bi-directional data bus 330, and then using a ROM embedded Great Circle formulae, computes distances between adjacent coordinate pairs or sets. Once distances are determined, both velocities and accelerations can be computed, in that the GPS receiver is polled or interrogated at the rate of 5 data sets or pairs per second. Thereafter, the microprocessor 320 is programmed to output a logical 1 (output signal 350) from one of its digital outputs under any of the following conditions:
Velocity<2 MPH
Deceleration rate (dV/dt) exceeds 10 MPH/second.

In the alternative, some GPS receivers produce time stamped velocity data points, such that “Great Circle” calculations are not needed and the microprocessor can easily process both motion and deceleration parameters.

The logical 1 output signal 350 is fed to a hard wired OR gate that is part Display Board 400.

Display Board 400 contains inputs for three signals, as follows:

Signal Output signal 225 which has been combined in a logical OR mode with for output signal 280; both signals are derived from analog processing circuit 205, and will be a HIGH or 1 whenever the motorcycle velocity voltage signal 200 is <2 MPH or when the deceleration dV/dt is >10 MPH/second.

Signal 350, which is HIGH or 1 whenever the GPS/logic processing (Logical/GPS circuit 305) indicates velocity of, 2 mph or a deceleration rate dv/dt>10 MPH/second.

On this display board 400, there are two diodes, diode 410 and diode 415. These diodes, forming a logical OR gate, are fed into a buffer amplifier 420. Buffer amplifier 420 has an input that is normally is at a low input condition. When a logical 1 or HIGH appears at the output of (signal 225 OR signal 280) OR′d with output signal 350, the output of buffer amplifier 420, known or referred to as signal 460, changes to a HIGH or 1 state, illuminating the onboard brake light LED 440 that is part of this invention and which faces the traffic behind the motorcycle/vehicle. The same output signal 460 also can provide a signal to the motorcycle's own brake light, whereby braking motion that is sensed by the present invention can also be used to illuminate the external LED or incandescent bulb that forms the brake light that is part of the vehicle.

As is readily apparent, the deceleration and velocity parameters can be altered without detracting from the scope or utility of the invention. It is further obvious that either the analog circuitry portion of the invention or the GPS based digital implementation of the invention can be utilized in standalone fashion or incorporated as an inherent part of the motor vehicle without detracting from the scope of the invention.

We claim the following:

1. A warning light (brake light) illumination circuit whereby the velocity of the motor vehicle to which the invention is affixed is sensed, velocity and acceleration (deceleration) are derived for said vehicle, and a warning light is illuminated in accordance with preset conditions that correspond to rapid deceleration of said vehicle, a stationary condition of said vehicle, or a condition whereby said vehicle that is traveling at an extremely low velocity, and further whereby said invention has two independent means for sensing velocity and acceleration (deceleration).

2. The invention as in claim 1, whereby a voltage signal that is processed by the brake light illumination circuitry is provided by said motor vehicle and said signal is proportional to velocity.

3. The invention as in claim 1, whereby the same information (velocity and acceleration) is computed by the sensing of GPS coordinates by a GPS receiver contained within the invention, and causes illumination of said warning light.

4. The invention as in claim 1, whereby the illumination of said warning light can be automatically modulated in intensity or duty cycle response to braking, heavy deceleration, or stationary conditions of said motor vehicle.

5. The invention as in claim 1, whereby said warning light is contained within the invention.

6. The invention as in claim 1, whereby said warning light is the brake light that is part of said motor vehicle.

7. The invention as in claim 1, whereby even with loss or absence of said analog voltage signal from said motor vehicle, the position and velocity and acceleration (deceleration) of said motor vehicle can still be computed from internally generated GPS coordinates by the internal GPS receiver, thus causing desired illumination of said warning light.

8. A brake light illumination circuit whereby the velocity of the motor vehicle to which the invention is affixed is sensed by a GPS receiver, acceleration (deceleration) is derived for said vehicle from GPS coordinates or data from said GPS receiver, and a warning light is illuminated in accordance with said preset conditions (velocity and acceleration (deceleration)) that correspond to the movements of said motor vehicle.

9. The invention as in claim 8, whereby the illumination of said warning light can be automatically modulated in its intensity or illumination duty cycle in response to braking, heavy deceleration, or stationary conditions of said motor vehicle.

10. The invention as in claim 8, whereby said warning light is contained within the invention.

11. The invention as in claim 8, whereby said warning light is the brake light that is part of said motor vehicle.

12. The invention as in claim 8, whereby a signal from said GPS receiver is connected to the brake light system of the motorcycle so as to cause illumination of the brake light that is originally part of the vehicle.

13. The invention as in claim 8, whereby said GPS receiver is housed internally within said motor vehicle and is a part of the motor vehicle as assembled by the manufacturer of said motor vehicle.

14. A warning light (brake light) brake light illumination circuit whereby the velocity of the motor vehicle to which the invention is affixed is sensed by a analyzing a voltage signal provided by said motor vehicle, and a warning light is illuminated in accordance with said preset conditions (velocity and acceleration (deceleration)) that correspond to the movements of said motor vehicle.

15. The invention as in claim 14 the illumination of said warning light can be automatically modulated in intensity or duty cycle in response to braking, heavy deceleration, or stationary conditions of said motor vehicle.

16. The invention as in claim 14, whereby said warning light is contained within the invention.

17. The invention as in claim 14, whereby said warning light is the brake light that is part of said motor vehicle.

18. The invention as in claim 14, whereby said invention is incorporated as said part of the motor vehicle when said motor vehicle is constructed.

19. The invention as in claim 14, whereby said invention is packaged or housed separately from said motor vehicle, and is incorporated in said vehicle in aftermarket fashion.
